(19) United States
(12) Patent Application Publication
(10) Pub. No.: US 2026/0018057 A1
(43) Pub. Date: Jan. 15, 2026

(54) DRONE-BASED MONITORING SYSTEM FOR VEHICLE PARKING

(71) Applicant: Municipal Parking Services, Inc., Golden Valley, MN (US)

(72) Inventors: James Paul MARTIN, Minneapolis, MN (US); Mark J. MORAN, Austin, TX (US); Joseph M. Caldwell, Austin, TX (US)

(21) Appl. No.: 19/264,335

(22) Filed: Jul. 9, 2025

Related U.S. Application Data
(60) Provisional application No. 63/669,212, filed on Jul. 9, 2024.
(60) Provisional application No. 63/755,101, filed on Feb. 6, 2025.

(51) Int. Cl. G08G 1/14; G05D 1/248; G05D 1/646; G05D 105/80; G05D 107/80; G05D 109/25; G05D 111/10; G05D 111/30; G06T 7/70; G08G 1/017

(52) U.S. Cl. CPC G08G 1/148; G05D 1/248; G05D 1/646; G06T 7/70; G08G 1/0175; G05D 2105/80; G05D 2107/80; G05D 2109/254; G05D 2111/10; G05D 2111/32; G06T 2207/10032; G06T 2207/30252

(57) ABSTRACT

One or more unmanned or remotely controlled flying devices (a/k/a “drones”) are utilized as part of a parking management system to capture images and/or video for the purposes of recognizing vehicles located in parking (or no parking) locations. The image data is relayed to a remote computing system that can be is programmed to specifically identify a vehicle based upon its license plate and/or and unique characteristics of the vehicle (Handicap Placard, Parking Stickers, Make, Model, Color, Registration Stickers, etc.). This information is used to determine if the vehicle has the appropriate credentials to be parked at its location and to assess any parking charges and/or fines for violations. Images from satellites can be used to determine locations to image with the drones.

### PRIORITY

This application claims priority to and the benefit of U.S. Provisional Patent Application No. 63/669,212, filed Jul. 9, 2024 and U.S. Provisional Patent Application No. 63/755,101, filed Feb. 6, 2025, both of which are incorporated fully herein by reference.

### FIELD

The present invention relates to devices, methods and systems for monitoring parking in a parking facility, and more particularly, to devices, methods and systems for monitoring vehicle parking in a defined area.

### BACKGROUND

Automated parking management systems for parking lots and ramps are disclosed, for example, in U.S. Pat. No. 10,121,172 B2, which is incorporated herein by reference in its entirety. Such systems utilize a plurality of fixed-in-place license plate recognition (LPR) cameras to identify vehicles entering and exiting the parking facility. Fixed-in-place cameras are also known to be used in street parking arrangements, such as disclosed, for example in U.S. Pat. No. 9,773,351 B2, which is incorporated herein by reference in its entirety. It is also known to use fixed-in-place cameras to monitor no-parking areas, such as adjacent to fire hydrants, fire lanes, etc., such as in U.S. Pat. No. 10,885,367 B2, which is incorporated herein by reference in its entirety. In all of these situations, it is necessary to install the cameras into the parking infrastructure so that the cameras can monitor vehicles entering and exiting the monitored parking or no parking areas. The camera hardware and corresponding installation of the same adds considerable cost to the overall parking management system. Locations that have a small number of parking spaces or a low volume of parkers doesn't make it cost effective either.

Another drawback of conventional parking management systems as discussed above is the inability to be easily deployed in temporary parking locations. For example, many festivals and fairs will utilize nearby fields as temporary parking lots. It would be cost prohibitive and inconvenient to install conventional parking management cameras in such locations. Thus, it is necessary to employ humans to collect parking fees and manage the temporary parking lot. These parking lot attendants add considerable costs to operating the temporary parking lot.

Therefore, there is a need for improved parking facility management systems, devices and methods that address some or all of the drawbacks of conventional management systems discussed herein above.

### SUMMARY

One or more unmanned or remotely controlled flying device (a/k/a “drones”) are utilized as part of a parking management system to capture images and/or video for the purposes of recognizing vehicles located in parking (or no parking) locations. The drones (also referred to as aerial drones and flying drones) are programmed to specifically traverse a territory to capture image data of each vehicle. This image data is uploaded from the drone to one or more remote-located computer systems. The image data can be analyzed by the remote computer system to determine the identification of the vehicle (e.g. license plate data via license plate recognition) and/or unique characteristics of each vehicle (handicap placard, parking stickers, make, model, color, year, license plate, registration stickers, etc.). The remote compute system can thus determine if the vehicle has the appropriate credentials (e.g., prepaid for the parking session, vehicle is registered as a valet vehicle, parking permit holder, registered with an account for autopayment of parking fee) to be parking at its location and to assess any parking charges for tabulation to notify the parker of the amount owed prior to exiting (or some time thereafter), determination of amount to charge for autopay registered vehicles, and/or fines for violations.

The image data includes time stamps. Additional data may be captured or included with the image data such as the exact parking stall or GPS location for a particular parked vehicle. This data can be used for purposes such as valet attendant needing to go retrieve the vehicle and being able to look up where the vehicle is located. This data also can be used by an individual to locate their car within the parking facility. There are additional uses of the location data to perform “retrieval, search and find” such as law enforcement, etc.

Satellite imaging can be used to determine whether vehicles are located in certain areas of interest, including both parking spaces and non-parking areas. Images captured by the satellites can be relayed to the remote computer system where the images are analyzed. GPS data for the drones can be updated to only have the drone image locations where vehicles are present. Parking enforcement personnel and/or towing personnel can be dispatched to locations of vehicles parked in both parking and non-parking areas.

The drones provide several advantages versus land-based vehicles. For example, since the drones fly through the air, they can avoid traffic and are able to get close up to their targets if desired. The drones provide better granular coverage in a parking facility. Moreover, the drones will lower the overall power costs as compared to the usage of land-based monitoring vehicles.

In one example disclosed herein, a parking monitoring system for a parking facility comprising a plurality of individual parking spaces is provided. The parking monitoring system includes a parking management computer system located remote from the parking facility and a flying drone. The flying drone comprises one or more fans coupled to a body to provide flight thrust to the flying drone, a battery provided to the body, a processor and memory disposed in the body, a wireless transceiver disposed in the body, a global positioning system (GPS) decoder disposed in the body, and a camera secured to the body. Software code residing in the memory and executed by the processor enables the flying drone to follow a predetermined flight path and obtain images of a plurality of individual parking spaces in the parking facility and wirelessly relay the images of the plurality of individual parking spaces to the parking management computer system via the wireless transceiver.

A drone dock located at the parking facility and configured to interface with the flying drone can be provided.

The images of the plurality of individual parking spaces are video segments and/or still images with encoded time stamps.

The parking management computer system is configured to analyze the images of the plurality of individual parking spaces to determine an identification of each vehicle parked in the plurality of individual parking spaces.

The software code residing in the memory and executed by the processor enables the flying drone to receive updated GPS coordinates from the parking management computer system and then utilize the updated GPS coordinates for a subsequent cycle of imaging of the plurality of individual parking spaces. The updated GPS coordinates correspond to vehicle location data obtained from a satellite image.

The software code residing in the memory and executed by the processor also enables the flying drone to send GPS coordinates to the parking management computer system for each image that the drone captures. The GPS coordinates can be encoded in the image data or sent separately.

The camera is mounted so that its elevation angle can be automatically adjusted. The camera can also automatically rotate its azimuth angle in further embodiments.

The flying drone can include four electric fans to provide flight thrust to the flying drone. More or fewer fans can be provided in other embodiments.

The flying drone can include an altitude sensor provided to the body.

The software code residing in the memory and executed by the processor enables the flying drone to perform a cycle of imaging of the plurality of individual parking spaces with a pre-set periodic frequency.

The parking facility can be a parking ramp, a parking garage, an open parking lot, a street segment or other predetermined area, including temporary lots.

Another example provided herein is a method of monitoring vehicles in a parking facility comprising a plurality of individual parking spaces. The method comprises a flying drone following a predetermined flight path and obtaining images of a plurality of individual parking spaces in the parking facility; the flying drone wirelessly relaying the images of the plurality of individual parking spaces to a parking management computer system; and the parking management computer system analyzing the images of the plurality of individual parking spaces to determine an identification for each vehicle parked in the parking facility.

GPS coordinates can be sent from the parking management computer system to the flying drone, wherein the GPS coordinates identify a plurality of locations for the flying drone to image. The drone can also send GPS coordinates for each image it captures to the parking management computer system.

Instead of needing GPS coordinates for each location to be imaged, the drone can begin imaging at a given GPS coordinate and then take subsequent images using an incremental interval measurement between image locations.

At least one altitude value can be sent from the parking management computer system to the flying drone, wherein the at least one altitude value identifies an altitude for the flying drone to obtaining the images of a plurality of individual parking spaces in the parking facility.

The parking management computer system can receive an image from a satellite orbiting Earth. The parking management computer system determines automatically from the image from the satellite what GPS coordinates for the flying drone are needed to image the vehicles located within the parking facility.

The flying drone can be docked upon completion of an imaging cycle.

The flying drone can perform its obtaining images of the plurality of individual parking spaces in the parking facility at a pre-set periodic frequency.

The parking management computing system can perform a diagnostics routine on the flying drone.

The flying drone can image locations where parking is prohibited.

The parking management computing system can automatically generate a parking violation notice for a vehicle imaged by the flying drone that is determined by the parking management computing system to be in violation status.

The above summary is not intended to limit the scope of the invention, or to describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a diagram of a parking management system for streets according to certain embodiments of the invention.

FIG. 2 is a plan view diagram of a parking management system for off-street parking according to certain embodiments of the invention.

FIG. 3 is a diagram of an integrated parking management system according to certain embodiments of the invention.

FIG. 4 is a perspective view of a camera bollard according to certain example embodiments.

FIG. 5 is a front view of a kiosk for a parking facility according to certain example embodiments.

FIG. 6 is a block diagram of certain components of a parking system according to certain example embodiments.

FIG. 7 is a diagram of a vehicle license plate being read by a camera as the vehicle passes by the camera device according to certain example embodiments.

FIG. 8 is a diagram of a parking facility system according to certain example embodiments.

FIG. 9 is a diagram of a parking facility system according to certain example embodiments.

FIG. 10 is a diagram of a parking facility system according to certain example embodiments.

FIG. 11 is a diagram of a parking facility system according to certain example embodiments.

FIG. 12 is a diagram of a parking system according to certain example embodiments.

FIG. 13 is a component diagram of a drone according to certain example embodiments.

FIG. 14 is a diagram of a satellite imaging vehicle locations according to certain example embodiments.

FIG. 15 is a flow chart of steps for performing a drone parking monitoring cycle according to certain example embodiments.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various example embodiments; nevertheless, these embodiments are not intended to limit the present invention to any specific example, environment, application, or particular implementation described herein. Therefore, descriptions of these example embodiments are only provided for purposes of illustration rather than to limit the present invention. The various features or aspects discussed herein can also be combined in additional combinations and embodiments, whether or not explicitly discussed herein, without departing from the scope of the invention.

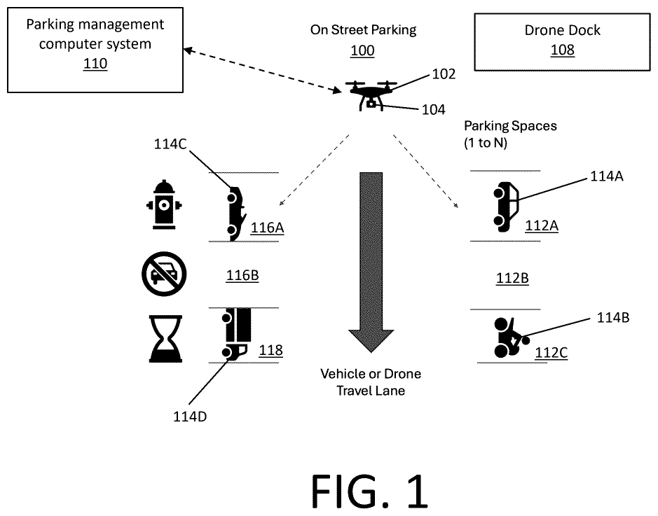

Referring to FIG. 1, illustrated is a parking management system 100 for street parking and no-parking locations. An aerial drone 102 is provided with a camera 104 so that the drone 102 can move about an assigned territory and capture images or video of the various vehicles located in the assigned territory. The assigned territory can be a particular segment of street such as a single block, multiple blocks, one or more bike, fire, bus lanes (or other areas where parking or stopping is prohibited), loading zones, electric vehicle charging space(s) or a wider area depending on the user's particular choices, and any combination of areas where monitoring of vehicles is desired.

The drone 102 can also be programmed to capture images and data on one side of the street or the other to assist in the enforcement of certain restrictions on parking such as no parking snow removal in effect (e.g. snow emergency routes) and time restrictions such as loading zones and delivery zones. For example, in many locations when winter parking rules are in effect, parking on the East side of the street is only permitted on certain days vs. parking on the West side of the street on alternate days. The data collected by the drones 102 could be leveraged to assist cities and plow companies to notify Tow companies to remove vehicles that exist prior to the snowplow arriving.

Drone 102 follows a pre-set flight pattern in its territory and images each parking/no-parking location that it is programmed to image. Each location to be images by the drone 102 in the territory is defined via a unique GPS location for one or more location to be imaged. By imaging all of the possible monitored locations, an accurate tally of occupancy can be determined. Alternatively, the drone 102 can be programmed to determine whether a given monitored space is occupied and then image only those locations that are occupied. Further alternatively, the drone 102 can receive updated instructions to image only certain locations for a given imaging cycle.

A dock 108 (also referred to as a house) can be provided onsite or nearby the drone's territory so that the drone can recharge between imaging cycles of its territory. The dock 108 can be configured to extract data from the drone. This results in more cost-effective data transfer and storage. The extracted data may temporarily remain at the dock 108 before being transferred to a central computer (parking management computer system 110) for further use and processing. Alternatively, the parking management computer system 110 could be located within the dock 108 itself. The dock 108 or house can also be located at a central location for housing/docking drones for multiple different territories. The drone can also directly upload its imaging data directly to the cloud or other remote computing system via a wireless transceiver.

The drone 102 can be programmed to perform an imaging cycle at regular intervals (frequencies) as set by a user or an automated process dictated by the central control computing system. For example, the drone 102 can be programmed to perform an imaging cycle every 10 minutes, 15 minutes, or specific days or timeframes (such as the start of an event, winter rules in effect, bus route hours) etc. The frequency will take into account limitations due to the drone's speed, recharge time, amount of data captured, weather conditions (when beyond the limitations of the drone), number of locations to image, and distance that must be covered in a given cycle.

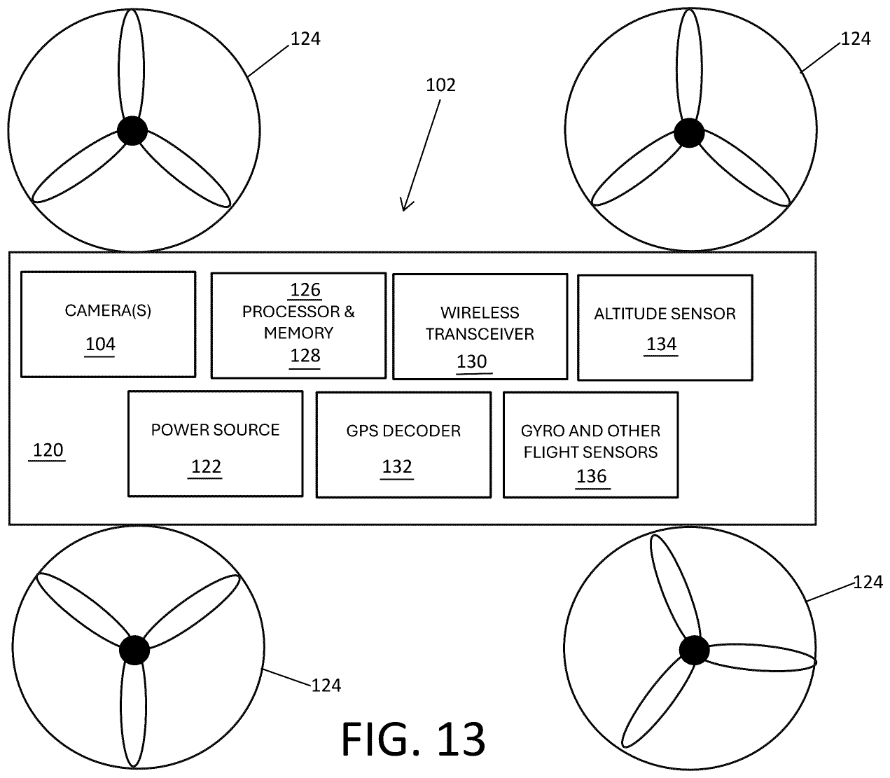

Referring to FIG. 13, the drone 102 includes a main body 120 that houses various electrical components and the power source 122 such as a battery. One or more propellers or fans 124 are coupled to the body 120 to allow the drone to fly through the air. There are four fans 124 depicted in FIG. 13, but more or fewer fans can be provided in alternative embodiments. The fans can rotate about one or two axes each in order to allow the drone 102 to control its flight heading, altitude, attitude, etc., as well as adjust its pitch, roll and yaw.

The drone 102 further includes one or more onboard processors or microprocessors 126 with corresponding physical memory 128. The processor 126 executes computer readable program code that is stored in the onboard physical memory (e.g., random access memory, flash memory or hard drive) 128. The computer readable program code is configured such that when executed by drone's onboard microprocessor(s) 126, the code causes the drone 102 to execute its pre-programmed flight path, perform its imaging and perform some or all other steps of the invention described herein.

Similar computer hardware and code may be located within the dock 108 to perform some, or all of the steps of the invention described herein that are related to the processing of the data captured by the drone itself.

One or more cameras 104 are provided to the drone. At least one of the cameras is mounted on a swivel and rotational plate so that it can adjust its elevation and azimuth angle. Alternatively, only the elevation is adjustable since the drone 102 can rotationally orient itself to adjust the azimuth angle of the camera for an imaging operation. At least one of the cameras 104 on the drone 104 is a high definition camera or a 4K resolution camera. The camera's zoom, focus and resolution settings cam be automatically changed as needed during the imaging process to obtain a high quality image of the vehicle and/or portions of the vehicle.

A wireless transceiver 130 is also disposed inside of the body 120 of the drone 102. The wireless transceiver 130 allows the drone to send and receive wireless communications, such as, for example, cellular data, wi-fi, Bluetooth, etc.

The drone further includes a global positioning system (GPS) decoder 132 onboard. The GPS decoder 132 allows the drone 102 to know its exact location based upon GPS coordinates. Those coordinates can be used to define a flight path for the drone. It also allows the drone to be instructed to image specific locations based upon the GPS coordinates of such locations. GPS data for flight path and/or imaging can be uploaded to the drone 102 wirelessly such as via cellular or wi-fi.

The drone 102 includes an altitude sensor 134. The altitude sensor 134 provides the drone with its measured height above the ground. This sensor can be a pressure sensor, sonar, radar, laser or other altitude sensing means. Additional sensors can be provided as needed to provide flight data to the drone, including one or more gyron sensors 136. The gyro sensors 136 allow the drone 102 to determine its relative orientation to the earth. An onboard compass can also be provided in the drone 102.

The drone 102 transmits the imaged data to a parking management computer system 110 (also referred to herein as a central computer or central control computer). The transmission can be wireless, utilizing any conventional wireless transmission means. The parking management computer system 110 can be located onsite (e.g., next to or contained within the dock 108) or nearby the drone's territory, or the parking management computer system 110 can be at a remote location or the parking management computer system 110 can be a cloud-based computing system, or a combination of cloud and remote computer systems.

The house dock 108 can be configured to be used as a temporary setup and is mobile. The dock need not be a permanent structure or setup.

The dock 108 can also be networked with the parking management computer system 110 so that the drone 102 can transmit its imaging data to the parking management computer system 110 when docked. The dock 108 can also serve as a transmission point so that the drone 102 can transmit its data to the parking management computer system 110 via the dock 108.

The camera 104 disposed on the drone 102 enables the drone 102 to capture images (image data), including one or more vehicle characteristics. The drone 102 may process some of the image data onboard such as determining if a license plate exists or not, if the license plate can be interpreted (read), etc. Some or all of the processing of the image data can also be performed elsewhere, such as at the dock 108 and/or by the parking management computer system 110.

The camera 104 of the drone 102 can be a license plate reading (LPR) camera where plates of vehicles exiting each sublot can be read. Other characteristics of the vehicle besides their license plate can be read/utilized/determined (such as make, model, color, size, shape and/or year) to establish a “parking session” or event of entry and exit a monitored parking location in the drone's territory. The characteristics can be determined by the parking management computer system 110 based upon the image data collected and transmitted to the parking management computer system 110 by the drone 102. The characteristics can alternatively be determined by the computing systems onboard the drone 102 in alternative embodiments.

The parking management computer system 110 can also upload or transmit data and code to the drone 102. Thus, the drone's operating parameters, such as imaging frequency, flight path, territory and target imaging locations can be changed as desired by a user and/or as dictated by the parking management computer system 110. The parking management computer system 110 can upload or transmit data to the drone for it to perform special data captures or modify its territory temporarily for a unique use case. For example, the drone can be programmed to capture only specific types of vehicles or vehicles with specific characteristics (e.g., handicap hangtag or lack of one, non-electric vehicle type, etc.) or specific locations within the territory.

Diagnostics can also be performed on the drone 102 via the parking management computer system 110. The diagnostics can be initiated manually by a user or can be performed at preset time periods and/or when the drone 102 is docked.

The parking management computer system 110 manages each parking session occurring in the parking facility 100 or in multiple facilities. The parking management computer system 110 includes microprocessors, memory and computer code that enable the parking facility management system to analyze the imaged data and perform all of the steps of the parking methods disclosed herein.

Additional details of parking session monitoring and management are disclosed in published U.S. Patent Publication No. US 2023/0082134 A1, which is hereby incorporated herein by reference in its entirety.

The parking management computer system 110 can comprise a parking permit database to store vehicle identifications and/or image data for vehicles with permits for parking in the monitored parking spaces. Time stamps for each captured image or each vehicle can also be stored in a database by the parking management computer system 110.

Referring specifically to FIG. 1, there are illustrated a variety of parking/no parking/restricted locations to illustrate the versatility of the present invention. On the right half of the figure, three paid parking spaces 112A, 112B and 112C are shown. When the drone 102 performs an imaging cycle, the vehicles 114A and 114B are imaged in their respective spaces 112A and 112C. The images captured by the drone 102 are time stamped or encoded so that the parked vehicles 114A and 114B can be charged for parking and violations accordingly.

The parking management computer system 110 receives the image data from the drone 102, including image data for the vehicles 114A and 114B. The image data is sent wirelessly by the drone 102 or by the dock 108 to the parking management computer system 110. The parking management computer system 110 determines a time that these vehicles were imaged and whether they were previously imaged (i.e., a parking session state has not changed). If a vehicle is determined to be newly parked in one of the spaces 112A, 112B and 112C, the parking management computer system 110 initiates a parking session for that vehicle and counts time from the moment of first imaging that vehicle in that space. The parking management computer system 110 determines a vehicle identification (e.g., license plate number or other data) and checks to see whether the vehicle is listed in the database of permit holders or parking account subscribers or whether a payment has been made for that vehicle (or will be made because it is registered to an autopay account) for the current parking session. If each finding is negative, then a violation may be issued to the owner of the vehicle, or a parking enforcement person can be notified to place a violation notice on the vehicle. A grace time period can be provided to ensure that a parker has reasonable time to pay for their parking time if they are not a permit holder or do not have a parking subscription account (an account where parking fees can be automatically deducted for the parking session, such as an autopay or pay as you go account).

The drone 102 can also include a printer so that the drone can print a physical ticket or violation notice. Then the drone can place that notice or ticket on the vehicle, such as on the windshield. The drone 102 can also notify a booting or towing company to boot or tow the vehicle that is in violation status. Alternatively, the parking management computer system 110 can notify a booting or towing company to boot or tow the vehicle that is in violation status.

U.S. Pat. No. 11,574,507 B2 discloses a parking app that can be used with a user's smartphone to interact with the parking management computer system 110. U.S. Pat. No. 11,574,507 B2 is incorporated herein in its entirety.

U.S. Pat. No. 11,810,403 B2 discloses a parking subscription service that interacts with a parking kiosk or meter, parking app on a smartphone or QR code to transmit data (including any data inputted by the user such as a license plate) to its networked systems for each parking event which is managed by the parking management computer system 110. U.S. Pat. No. 11,810,403 B2 is incorporated herein in its entirety.

US Patent App Pub. No. US 2024/0257523 A1 discloses a parking system where a secondary camera is provided to generate temporary permits. The drone could serve as the secondary camera in such embodiments. US Patent App Pub. No. US 2024/0257523 A1 is incorporated herein in its entirety.

US Patent App Pub. No. US 2024/0371270 A1 discloses a parking system where cameras are provided to monitor vehicles entering and/or exiting sublots in a parking facility. The drone or multiple drones could serve as the cameras in such embodiments. US Patent App Pub. No. US 2024/0371270 A1 is incorporated herein in its entirety.

FIG. 1 also depicts two “no parking” spaces 116A and 116B or locations where parking is not allowed. Location 116A is adjacent to a fire hydrant and location 116B is clearly marked as parking being prohibited with appropriate signage. A vehicle 114C is shown parked in location 116A next to the fire hydrant. Drone 102 images vehicle 114C in this “no parking” location as part of its circuit and uploads the corresponding imaging data to the parking management computer system 110. The parking management computer system 110 then determines the vehicle's identification and issues a violation notice to the vehicle's owner automatically, or the parking management computer system 110 can summon a parking enforcement person to issue a physical notice to be left on the vehicle, or the parking management computer system 110 can generate a violation notice for subsequent printing and mailing. Again, the drone 102 can include its own printing device to place the ticket on the vehicle. The drone 102 can also retrieve a physical ticket from a printer and place the ticket on the vehicle. Parking management computer system 110 can additionally call a towing service automatically to have vehicle 114C removed.

FIG. 1 further illustrates a “restricted” or limited occupancy parking space 118. The limited occupancy space in the depicted example is a loading zone. The limitation can be a time duration (e.g., 30 minutes), type of vehicle or other type of restriction. The drone 102 images the vehicle 114D in the limited occupancy parking space 118 with each cycle and the parking management computer system 110 uses the time stamp data in the image data to calculate whether the vehicle 114D in space 118 has remained there in excess of the maximum time limit. If the time limit is exceeded, then a violation notice is issued in one of the manners noted above, and a tow service may be automatically called to remove the vehicle 114D.

The limited occupancy parking space 118 could also be a handicap permit only space or other limited permission space such as permit holders only or official government vehicles only, etc. In such spaces, the drone imaging data can be used by the parking management computer system 110 to determine whether an appropriate permit is displayed and/or whether the vehicle's identification is listed in a database of vehicles authorized to park in the limited space 118. If the vehicle is determined by the parking management computer system 110 to not be authorized, then a violation notice can be issued as discussed above. Plus, a towing service can be automatically called.

The limited occupancy parking space 118 could also be an electric vehicle charging space that is adjacent to a charging station. In such spaces, the drone 102 imaging data can be used by the parking management computer system 110 to determine whether the type of vehicle is such that it can be charged by the charging station adjacent to the space 118. A database of vehicles that can be charged by the charging station adjacent to the space 118 can be provided to the parking management computer system 110 for comparison purposes. If the vehicle is determined by the parking management computer system 110 to not be one that can be charged by the charging station adjacent to the space 118, then a violation notice can be issued as discussed above. Plus, a towing service can be automatically called.

The limited occupancy parking space 118 could also be some other limited permission space such as permit holders only or official government vehicles only, etc. In such spaces, the imaging data from the drone 102 can be used by the parking management computer system 110 to determine whether an appropriate permit is displayed and/or whether the vehicle's identification is listed in a database of vehicles authorized to park in the limited space 118. If the vehicle 114D is determined by the parking management computer system 110 to not be authorized, then a violation notice can be issued as discussed above. Plus, a towing service can be automatically called.

Near-field communication (NFC) devices on vehicles can also be read by the drones 102 in further embodiments. Examples of NFC and RFID devices that the drone can be configured to read include toll pass devices such as EZpass, MNpass and the like.

Two or more drones can be assigned to a given territory to increase imaging cycle frequency and/or provide for redundancy of imaging.

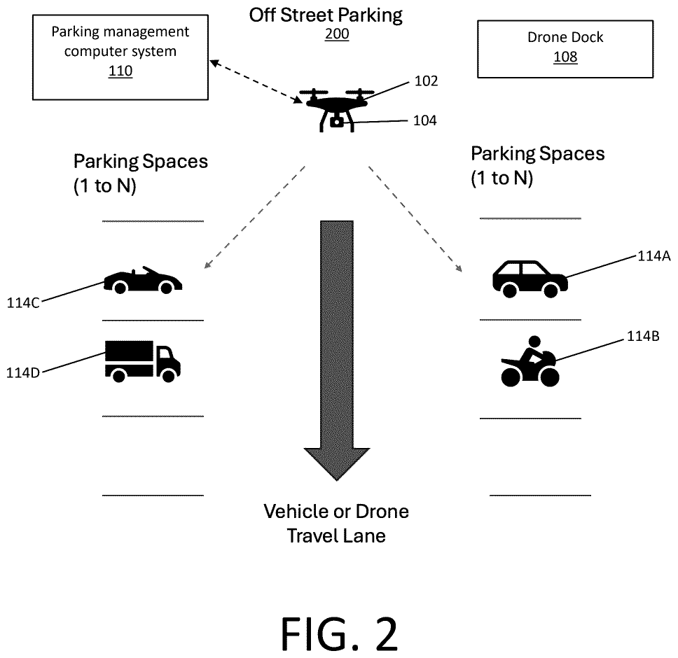

Referring now to FIG. 2, an illustration of an off-street parking management system 200 is depicted. The off-street parking facility may be a parking ramp, parking garage, open parking lot, street segment, or other defined area. The off-street parking facility can also be a temporary parking lot. The off-street facility can be divided into multiple territories or can be treated as one single territory. One or more drones 102 can be assigned to the facility or a territory in the facility and image the vehicles in the various parking spaces. As explained above, the drones 102 transmit the imaging data to the parking management computer system 110 which determines the vehicle identifications and charges each vehicle for the respective parking events. A dock 108 is again provided for the drone(s) similar to the explanation provided above regarding FIG. 1.

The parking facility may include “no parking” spaces, such as walkways, etc., and the drones can be used to monitor vehicles that park or dwell in such spaces so that violation notices can be issued as discussed above. Plus, a towing service can be automatically called.

In further alternative embodiments, the drones 102 can be used as a supplemental tool for parking management of a parking facility such as the facilities disclosed in U.S. Pat. No. 10,121,172 B2, U.S. Pat. Pub. No. 2024/0371270 A1 and U.S. Pat. Pub. No. 2024/0257523 A1, or for street parking systems such as disclosed in U.S. Pat. No. 9,773,351 B2. U.S. Pat. No. 10,121,172 B2, U.S. Pat. No. 9,773,351 B2, U.S. Pat. Pub. No. 2024/0371270 A1 and U.S. Pat. Pub. No. 2024/0257523 A1 are each incorporated herein by reference in their entirety. In such supplemental usage, the drones 102 can be used to determine specific parking locations for a given vehicle in a parking facility. For example, the entry cameras determine that the vehicle entering the parking facility is a non-permit holder. The drone can image the vehicles in the parking areas designated for non-permit holders to verify that the vehicle did not park in a permit holder area or other reserved area. This eliminates the need for additional fixed cameras to monitor vehicles entering and exiting separate sections inside of a given parking facility. The drones can be used to log a vehicle's location within a facility for any desired reason.

In some situations, fixed cameras are trained to image a vehicle's license plate. However, the particular vehicle parking in a given space may have a parking credential or pass, such as a handicap parking hang tag or a resident parking permit, which is not visible to the fixed license plate reading cameras. The drone 102 can be dispatched by the central control computer 110 when a vehicle enters a parking space with limited access to image the vehicle so that it can be determined if the vehicle is displaying the required credential, such as the handicap tag.

A drone 102 also can image a vehicle from multiple angles or do a full circle imaging of a vehicle. This additional imaging data along with GPS data for the images can be gathered that is not possible with conventional fixed-location cameras. The additional imaging data can be used by the parking management computer system 110 to analyze the location and shape of a vehicle to determine its make and model and/or color. The shape of specific details of the vehicle, such as its grill, wheel, etc. can also be imaged and analyzed.

A drone 102 can also be dispatched when a fixed license plate reading camera cannot read a vehicle's license plate. For example, a bike rack may obscure a vehicle's license plate. The drone 102 can collect imaging data that will enable the parking management computer system 110 to determine an identification from additional angles of images or even manage a parking session based upon vehicle characteristics such as shape, or make, model, color, etc. if a vehicle identification is not available. Some vehicles display temporary tags rather than permanent license plates, and the drone 102 is capable of providing images of the temporary tags that a fixed-location camera may not be able to view.

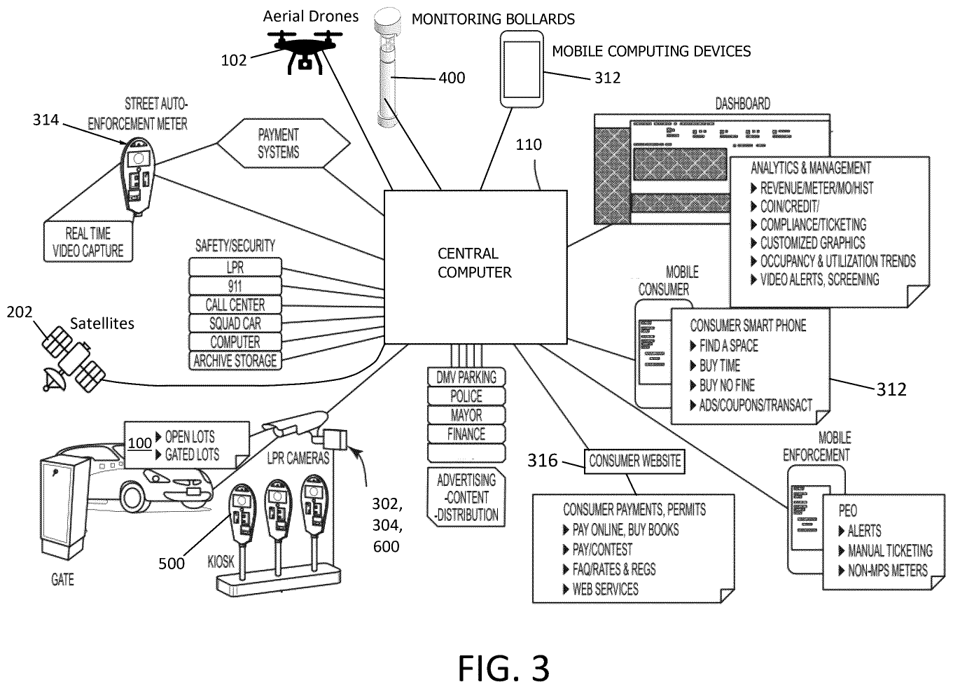

A network of drones for a plurality of on-street and off-street parking locations, and “no parking” areas, and restricted parking areas (both for as supplements to existing fixed-camera monitoring systems, and for drone-only monitoring systems) can be provided and managed by one centralized parking management computer system 110. FIG. 3 illustrates various components of such an integrated parking management system. A variety of devices are networked with the central computer 110, including a fixed entrance camera 302, a fixed exit camera 304, as well as a variety of additional devices that are part of an integrated parking management system, including user mobile computing devices 312, parking meters 314, vehicle monitoring bollards 400, parking kiosks 500 and additional monitoring cameras 600. Users can pay for their parking via an app executing on their mobile computing devices 312 that are networked with the central control computer 110 or via any computer 316 with internet access to a consumer website that interfaces with the central control computer 110. The entirety of U.S. Pat. No. 11,574,507 B2 is hereby incorporated herein by reference in its entirety.

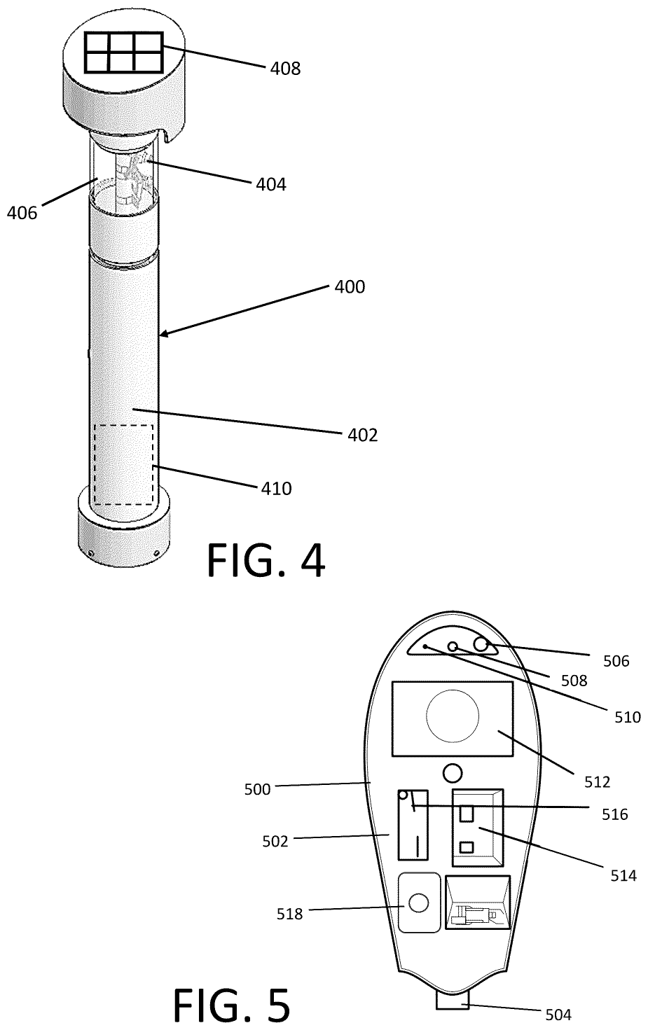

Referring to FIG. 4, any one or more of the fixed-location cameras 302, 304 can be configured as a bollard 400. The bollard 400 can be mounted or secured adjacent to a location that the vehicles will pass so that the camera will have an unobstructed view of the vehicle license plates. In one example, the bollard 400 comprises a weather-resistant outer enclosure 402 with one or more cameras 404 and other electrical components, such as the microprocessor and memory disposed inside of the enclosure 402. A portion of the enclosure 402 can be transparent (or semi-transparent) which defines a window 406 so that the camera(s) 404 can see the license plates of vehicles passing by the bollard 400.

One or more vehicle sensors can also be located inside of, or on the exterior of, the enclosure 402. A solar panel 408 can be provided atop the enclosure 402 to generate some or all of the power necessary to operate the camera(s) 404 and other components of the bollard 400. A battery 410 can also be disposed inside of the enclosure 402 to store energy generated by the solar panel 408 and to power the camera(s) 404 and other components of the bollard 400. In some embodiments the bollard 400 does not need to be connected to the power grid because the solar panel 408 and onboard battery 410 are sufficient to supply all power needs. The bollard 400 is networked with the central control computer 110 via wires or wirelessly. A wireless transceiver can be included inside of the housing 402 to enable the wireless networking.

Referring to FIG. 5, an example kiosk 500 is shown. The kiosk 500 comprises an enclosure or housing 502 mounted atop a pole 504. The housing 502 includes the electronics for controlling operation of the kiosk and for networking the kiosk 500 with a central control computer system 110, including a microprocessor and memory. The housing 502 includes a speaker 506, a user-facing camera 508 and microphone 510 disposed adjacent to the graphical user interface (e.g., touch screen) 512. A payment acceptance means 514 and coin slot 516 are also provided. The payment acceptance means 514 can be a contactless or conventional card reader, or other known means for accepting payment. One or more cameras 518 are disposed inside of the housing 502 such that they can see the license plates of vehicles passing by the kiosk 500. A vehicle sensor can also be provided to the kiosk 500. Any one or more of the cameras 302, 304, can be configured as a kiosk 500.

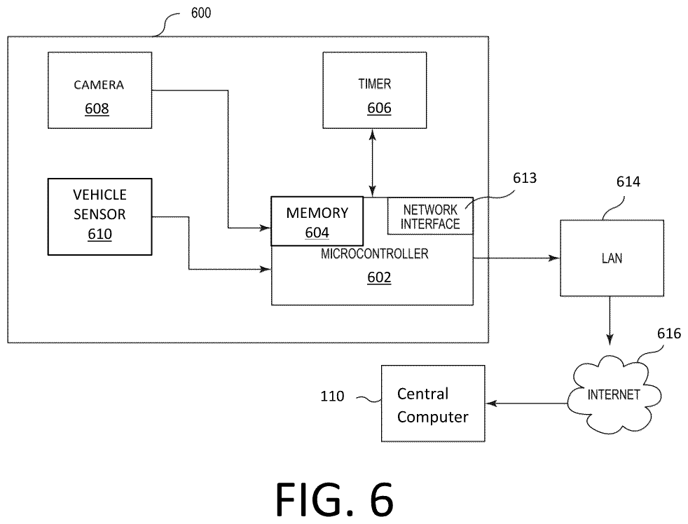

Referring to FIG. 6, a block diagram for certain embodiments of the present parking system is provided. The camera device 600 refers hereinafter to the drone's camera 104 and any of the fixed-location cameras 302, 304. Camera device 600 includes a microcontroller 602, or microprocessor, with associated physical memory 604. The software code controlling the operation and function of the camera device 600 is stored in the memory 604 and executed by the microcontroller 602. The memory 604 may include one or more non-volatile storage devices and/or one or more volatile storage devices (e.g., random access memory (RAM)).

Computer readable program code is stored in the memory 604, such as, but not limited to magnetic media (e.g., a hard disk), optical media (e.g., an OVO), solid state memory, memory devices (e.g., random access memory, flash memory), etc. The computer readable program code is configured such that when executed by the microcontroller 602, the program code causes the camera device 600 to perform the functions and steps described herein. In other embodiments, the camera device 600 is configured to perform steps and functions described herein without the need for program code.

A timer 606 can be coupled with and controlled by the microcontroller 602. The microcontroller 602 can also count processor clock cycles as a form of timer. The camera 608 (or multiple cameras) is/are coupled with and in two-way communication with the microcontroller 608. If provided, the vehicle sensor 610 is also operatively connected to the microcontroller 602.

Each camera device 600 is networked with the central or control computer 110. The camera device 600 includes a network interface 613 either integrated into the microcontroller 602, or as a separate component to enable the networking. The network interface 613 is configured to enable communication with a communication network (e.g., a local area network (LAN 614), the Internet or World Wide Web), using a wired and/or wireless connection. Network communication means include, but are not limited to, Wi-Fi, Bluetooth, cellular (HSPA, LTE, GSM, CDMA), DSL, cable, etc. The LAN 614 may include other camera devices and any kiosk(s), all in communication with one another at a given parking facility. In LAN configuration, the LAN 614 can be connected to the Internet 616 as illustrated in FIG. 6, so that communications with the cloud-based or central control computer system 110 can be accomplished.

The cloud, central or central computer system 110 (hereinafter the central computer) governs the operation of and/or stores the data from a given number of networked camera devices 600 and kiosks 500, including the drones 102. The central computer 110 may comprise one or more servers interfacing with networked storage in a data center. The central computer 110 can be located remotely in a secure location for convenience and security purposes (or can be local or onsite at the facility). The LAN 614, in turn, is connected to the World Wide Web (i.e. Internet) in order to be in communication with a variety of other computing systems, including law enforcement, operations companies, user mobile devices, user web interfaces and security services, etc. such as indicated in FIG. 3. This way, the data collected by the cameras 600 and inputted into the overall integrated parking management system by administrators, users and others can be securely stored and reviewed by appropriate authorities and the operations of all camera devices 600 in a given parking system can be monitored and remotely controlled via the central computer 110.

The LPR function can be performed onboard the camera devices 600 by the microcontroller 602 using LPR software stored in the memory 604. The LPR function can also be performed by a remotely-located computer system, such as the central computer 110. In such embodiment, the central computer 110 performs the character recognition on image data provided by the networked camera device 600.

A decoder can also be included in the camera device 600 to decode an identification where the license plate (or other part of the vehicle) is equipped with a radiofrequency identification (RFID) tag. In addition, the camera device 600 can be programmed to decode machine-readable glyphs and visual encodings, such as barcodes and matrix barcodes (e.g., QR codes), in order to read such encoded items on the vehicle's plate or other portion of the vehicle. Multiple decoding/reading means can be included in a given camera device 600 (or multiple separate devices can be provided) to allow the parking system to adapt to a variety of identification methodologies.

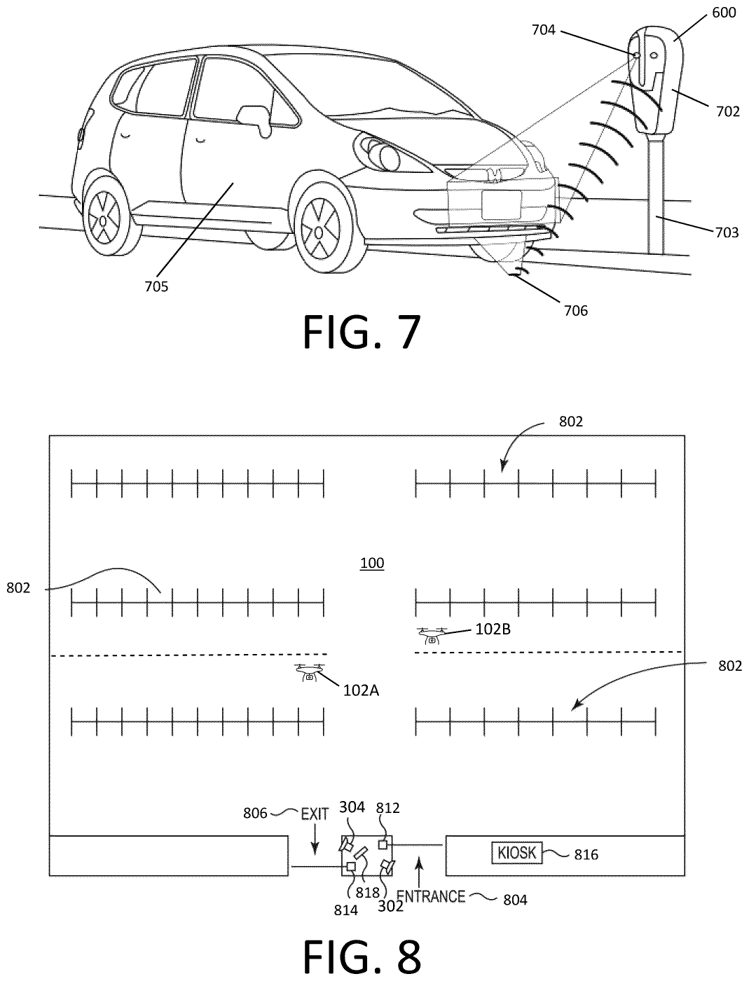

Referring to FIG. 7, the camera device 600 is enclosed in a camera housing 702 that can be placed adjacent to the entrance or exit of the parking facility 100, in individual lots within the parking facility 100, or in any other desired location. The camera housing 702 can be disposed atop a pole 703 that is secured to the ground. The camera housing 702 can be configured as a bollard (e.g., FIG. 4), kiosk (e.g., FIG. 5) or other suitable configurations in other embodiments.

One or more individual cameras 704 can be disposed inside of the housing 702. The camera(s) 704 views outward through a window in the housing 702 or directly from the housing 702. The camera(s) 704 can also be mounted externally to the housing 702. The camera(s) 704 can also be mounted on a pole separate from the housing 702 as a further alternative.

Also enclosed with the housing 702 are microprocessor(s), memory and computer code that enable the camera(s) 600 to read the license plates of vehicles 705 entering/exiting the parking facility 100 and/or passing through the lots in the parking facility, as well as obtain still images and/or video of the vehicles 705.

In certain embodiments, a vehicle sensor 706 can be embedded in the ground below, on the pole 703, in the housing 702, or somewhere adjacent to, the vehicle 705. The vehicle sensor 706, such as a magnetic sensor, a radar sensor, sonic sensor or laser sensor, can be used to detect the presence of a vehicle to serve as a double-check on a vehicle detection function of the camera device 600, or it can serve as a low-power sensor to wake up the camera device 600 from a dormant or power-conserving state. The vehicle sensor 706 can also be a second camera. A drone 102 can provide a further check on or verification of a vehicle detection function and provide the status of a vehicle presence to the parking management system. The drone 102 can also be programmed to only provide this check/verification function when a primary or secondary detection source (such as a sensor described above) is not performing accurately or is offline.

The vehicle sensor 706 broadcasts a status message or output value to the nearby camera device 600 as shown in FIG. 7. The broadcast can be performed using low power Bluetooth or other short range wireless communications protocol. The broadcast frequency can be continuous or periodic. For example, the status of the vehicle sensor 706 can be broadcast once per second, ten times per second, etc.

In one preferred embodiment, the vehicle sensor 706 is powered by an internal lithium-based battery and a sensing/broadcast cycle is performed once per second in order to conserve battery life. A sensor life expectancy of several years can be achieved using such battery and operating method. In other embodiments, the sensor 706 can be hard-wired for power and/or broadcast.

In embodiments where the vehicle sensor 706 is integrated into, or located adjacent to, the camera device 600, the sensor 706 can be coupled to the camera 600 via internal wires (if internal) or via an electrical conduit (if external). The conduit can carry both power and data bi-directionally, or separate power and data conduits can be provided. More than one vehicle sensor 706 can also be employed.

The camera or cameras 604 disposed in the camera device 600 (or remotely from the housing 602 as discussed above) use image sensors (e.g., ccd or cmos) and can apply a machine vision technique such as background subtraction and/or edge detection to determine whether a vehicle 105 is passing into or out of a given lot or the parking facility. Note that the background subtraction methodology can also be referred to as foreground subtraction and foreground detection. Edge detection, or other suitable optical sensing means, can be employed in other embodiments. A combination of detection methodologies can also be combined or used as a double-check on the other.

Referring now to FIG. 8, an example of an automated parking facility 100 such as a parking lot or parking ramp will be described. The description below uses the term “lot” but it should be understood that the present invention can be used for any form of parking facility.

The parking lot 100 comprises a plurality of parking spaces 802. The vehicle entrance 804 and exit 806 to the lot 100 are each monitored with a respective entrance/exit camera device 302, 304 located adjacent to the respective entrance 804 and exit 806. Vehicles in the lot 100 are monitored by the drones 102A and 102B, which serve to monitor where each vehicle in the lot is parked by imaging each individual parking space and other area of interest (e.g., locations adjacent to sidewalks and fire hydrants, etc.). There can be multiple entry/exit points and sublots, each with a corresponding camera device and/or drone. Each camera and drone collect images of vehicles so that the vehicle identification (ID) (e.g., license plate numbers/letters or other characters) of every vehicle entering/exiting/parking in the parking lot 100 can be determined. The decoded vehicle IDs are stored in memory as described herein. Additional vehicle characteristics can be read as discussed previously.

A gate 812 can be optionally provided to the entrance, and a corresponding gate 814 to the exit, to bar passage of a vehicle for various reasons, such as when the lot has reached capacity, or any time a vehicle is not permitted in the lot, or to cause a violator to pay a fine prior to exiting. Gates can also be provided between sublots.

One or more kiosks 816 can be provided to the parking facility 100 in a location convenient to persons parking in the facility 100. The kiosk 816 can be used to submit payments for parking time, to pay fines, to obtain/provide information, etc. In one example embodiment, a kiosk 816 can be provided at the entrance or exit so that the user can provide their payment information upon entrance to or exit from the lot 100. The kiosk 816 can be integrated into the same housing as the camera device 302, 304 as well. The kiosk 816 can be communicatively coupled (e.g., networked) to the drones 102A, 102B and camera device(s) 302, 304, etc. as part of an integrated parking system as described herein.

In locations where vehicles have only rear license plates, the entrance 804 or exit 806 are correspondingly configured so that the fixed camera devices 302, 304 are placed and aimed so that the rear license plate can be effectively read. Multiple fixed cameras can also be provided (either in a single housing or in separate housings) at a given location to capture and read both the front and rear license plates of each vehicle passing by. A message board 818 can also be provided at the entrance and/or exit of the lot 100 to provide information to users, such occupancy status, pricing information and other messages.

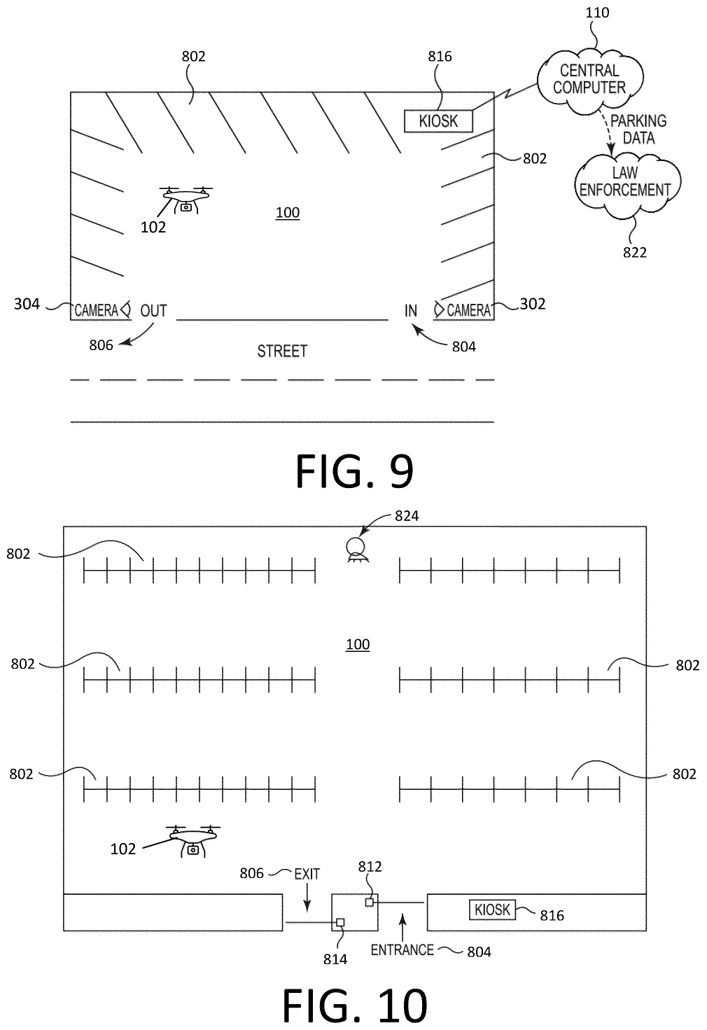

The electromechanical gates 812, 814 can be eliminated, if desired. Such gates are costly and can fail. Referring to FIG. 9, a gateless parking facility 100 configuration is depicted. In this example, the parking lot 100 is shown with one entrance 804 and one exit 806 for simplicity of explanation, but multiples of each can be provided. Fixed camera devices 302, 304 are placed at the respective entrance 804 and exit 806 of the parking lot 100. A drone 102 is provided as a supplemental imaging device. A kiosk 816 is also provided to the lot 100. The drone 102 and camera devices 302, 304 are networked with the central computer 110 to report all vehicle data and image data.

The image data from the drone 102 and/or any of the camera devices 302, 304 can also be automatically relayed to law enforcement systems 822. This allows law enforcement agencies to perform real-time monitoring of who/what is parked where, to compare vehicle ID's (e.g., plates) against a stolen car database, or compare ID data against a person of interest database, or other analysis related to public safety and security. Such processes can be used by law enforcement for monitoring/investigation of Amber alerts, stolen vehicles, scofflaws, felons and crime prevention, among other security related applications. This law-enforcement coupling embodiment could greatly reduce crime and increase the productivity of law enforcement agencies locally, regionally and nationwide. It would be a unique addition to the intelligence gathering done by police today, and an incremental benefit to the communities served.

In FIG. 10, the separate entrance/exit camera devices 302, 304 are replaced with a single fixed camera device 824 mounted at an elevated position above the parking facility 100. Again a supplemental imaging drone 102 is provided. The elevated position can be, for example, at the top of a pole in a position that the camera device 824 can see the entrance 804 and exit 806 simultaneously within the camera's fixed field of view. The elevated position allows the camera device 824 to read the license plates of all cars entering and exiting the parking lot 100 as well as determining which sublot in which each vehicle parked.

The single camera embodiment reduces the equipment costs and places the fixed camera device 824 in a location with lower likelihood of damage due to vandalism. The camera device 824 can also be equipped with motors to selectively adjust rotation angle (azimuth) and elevation angle. The lens of the camera device 824 can also be equipped with zoom capability.

The fixed camera device 824 can also be eliminated completely. The drone 102 thus functions as the vehicle monitoring means in this example. Multiple drones can be provided to adequately cover the lot 100 if necessary.

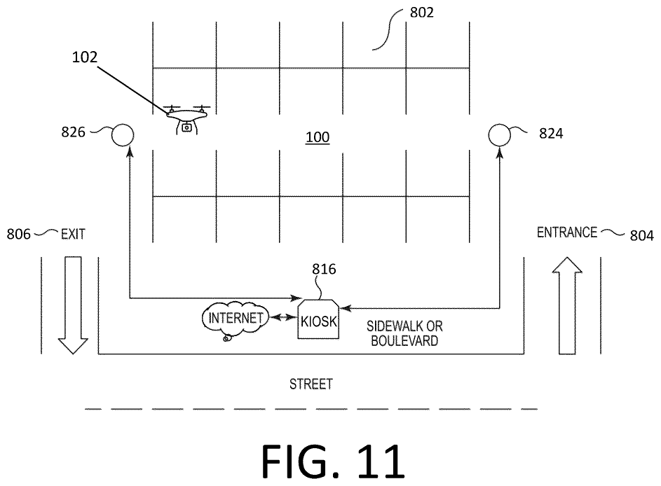

Additional entrances/exits, as well as sublots within the lot, can be monitored with the same single camera device 824, if they are in that camera's effective field of view. If not in the field of view, then one or more additional elevated camera devices 826 can be utilized as shown in the alternative configuration of FIG. 11. A combination of camera devices 302, 304 at entrance/exit and elevated positions 824, 826 can also be used in further embodiments. Control gates 812 and 814 at the entrance 804 and exit 806 can be provided as an option. Again, the fixed cameras 826 can also be eliminated and the functions of said fixed cameras performed by one or more drones 102.

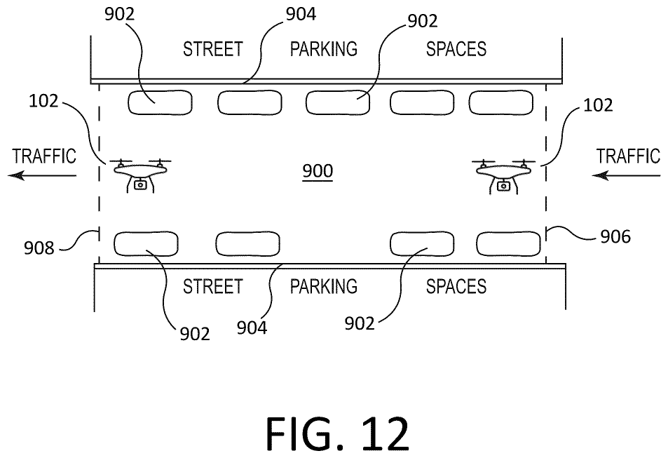

Referring now to FIG. 12, a system for managing parking on a street segment 900 using a minimal number of meters (or even no meters) is shown. A plurality of parking spaces 902 are defined longitudinally along the opposing curbs 904 on a section of a street 900. The depicted street is for one-way traffic, but this embodiment is applicable to two-way traffic as well.

One or more drones 102 are provided to monitor vehicles crossing the entrance 906 and/or exit 908 of the defined street portion, thereby defining a monitoring system. The drone(s) 102 of the monitoring system image the license plates and/or the vehicle of each vehicle passing into and/or out of the street segment 900 and report the image data to the central control computer 110. This arrangement permits the parking system to count cars, identify cars specifically, and determine just how long each vehicle has dwelled on that street segment 900. Dwell time on the street segment 900 is determined for each vehicle, including vehicles that are parked, vehicles that drop off or pick up passengers or goods. The system can determine if the car was parked and for how long, whether it was double parked—for how long—and provides the added security features in the above embodiments. The drones can also determine if a vehicle parked on the street segment 900 is parked illegally, such as adjacent to a fire hydrant, in a crosswalk, etc.

This system can also accommodate situations where there are other exits, or parking lots along the same street because of the mobility of the drone(s) 102. Additional drones can be provided where necessary. In addition, the drones can be supplemented with placement of fixed cameras mounted in positions to view the vehicles in the street segment 900.

This embodiment can be used to totally eliminate the need for meters on those streets where this would be applied and effective. Users could be permitted through preregistration to park for pre-assigned periods, with or without parking charges as the permit allows.

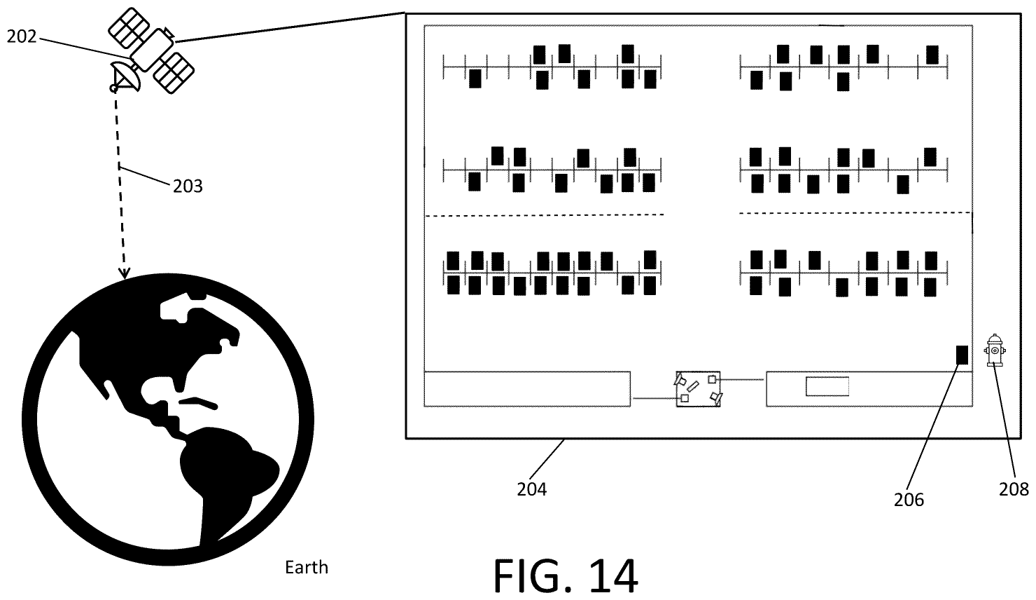

In another aspect, satellite images of a given territory are provided to the parking management computer system 110 via wireless transmission 203. Referring to FIG. 3 and FIG. 14, one or more satellites 202 orbiting earth periodically take images of certain areas of the surface of the Earth. These images, such as the depicted example image 204, show sufficient resolution to depict the location of possible vehicles in given locations. Each location is assigned a GPS coordinate. Thus, the parking management computer system 110 can use such satellite imagery to determine the occupancy status of each parking space depicted on the image. This allows the parking management computer system 110 to send only those coordinates to the drone 102 where the drone is to perform an imaging task. Thus, the drone's time and energy expended to perform one cycle of imaging is reduced since empty spaces are not imaged. Transmission bandwidth for the image data is reduced as well.

The parking management computer system 110 can also match up the image data obtained from the drone(s) to the image data obtained from the satellite(s) to verify that a given vehicle was present in a given location at a given time or for a given duration to time. The satellite data thus provides further evidence beyond the images obtained via drone that the given vehicle was present in a specific location at a particular time or for a particular duration of time, and vice-versa.

The parking management computer system 110 can also determine from the satellite image data whether a vehicle is potentially parked in a restricted or no-parking area. It can also be determined whether a vehicle is located in an area where parking is not expected for longer than a pre-set duration of time. In each of these instances. The parking management computer system 110 can dispatch a drone 102 to image the possible vehicle in the location in question even if the location is not part of the drone's regular territory. For example, in FIG. 13, the vehicle 206 is parked not in a regular parking space, but an unmarked location that is adjacent to a fire hydrant 208. The parking management computer system 110 in such situation learns of this vehicle's illegal parking from the image 204 from the satellite 202 and dispatches a drone 102 to image the vehicle 206.

In yet another aspect, the parking management computer system 110 can report the illegally parked vehicle 206 to law enforcement personnel, to parking enforcement personnel, to a tow service and/or to a boot service.

Note that the vehicle monitoring methods and systems using satellite imaging can be used for both on-street and off-street parking situations.

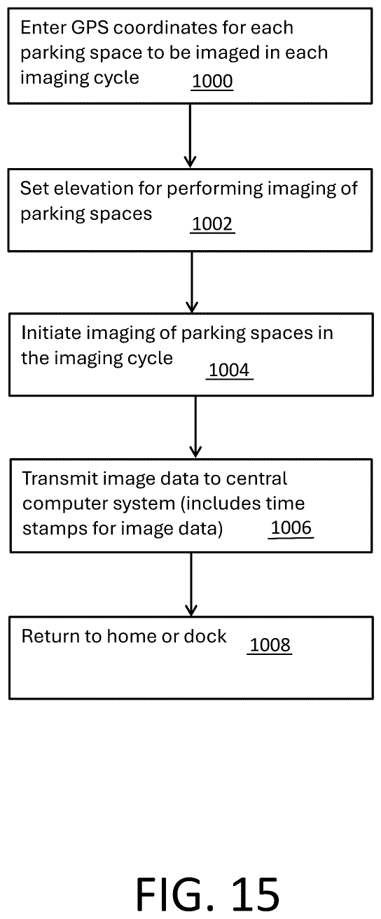

Referring to FIG. 15, an example use of a drone 102 for parking monitoring will now be described. The drone is enabled by providing it with the GPS coordinates for each parking space to be imaged in each imaging cycle 1000. A given flight path and any obstacles to be avoided during an imaging cycle can also be provided if needed for a given parking facility. This data can be entered by a human or automatically generated and sent to the drone via the parking management computer system 110.

Instead of needing GPS coordinates for each location to be imaged, the drone can begin imaging at a given GPS coordinate and then take subsequent images using an incremental interval measurement between image locations. For example, the drone can be programmed to start imaging at a given location and then take further images every 9.5 feet for the next images.

Next, the elevation for performing the imaging of the parking spaces is provided to the drone 1002. The elevation can be consistent for all spaces, but can be set on a space-by-space basis if needed. Again, this data can be entered by a human or automatically generated and sent to the drone via the parking management computer system 110.

Once the necessary set update is provided, the drone is initiated to image the parking spaces in an imaging cycle 1004. The initiation can be manual or automated. For example, the initiation can be based upon a countdown timer running from a previous cycle occurrence (e.g. 15 minutes). The countdown timer can be maintained by the drone or within the parking management computer system 110.

Upon completion of an imaging cycle, the drone 102 transmits its collected image data to the parking management computer system 110 in step 1006. The image data can be individual images and/or recorded video segments. The image data includes encoded time stamps. Thus, the parking management computer system 110 can determine the exact time when a given picture was taken or video segment was recorded. The drone can return to its dock or home 1008 after completing an imaging cycle. This step 1008 can be performed before or after step 1006.

Any additional methods and functionality of the systems disclosed in U.S. Pat. No. 9,870,648 B2 (Appendix A), U.S. Pat. No. 10,121,172 B2 (Appendix B), and U.S. Pat. No. 11,164,452 B2 (Appendix C) can be provided to the present system in additional embodiments hereof. Each of U.S. Pat. No. 10,121,172 B2, U.S. Pat. No. 11,164,452 B2 and U.S. Pat. No. 9,870,648 B2 are hereby incorporated herein in their entirety and appended hereto as part of this application.

While the invention has been described in connection with what is presently considered to be the most practical and preferred example embodiments, it will be apparent to those of ordinary skill in the art that the invention is not to be limited to the disclosed example embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A parking monitoring system for a parking facility comprising a plurality of individual parking spaces, the parking monitoring system comprising:
a parking management computer system located remote from the parking facility; and
a flying drone, comprising:
one or more fans coupled to a body to provide flight thrust to the flying drone;
a battery provided to the body,
a processor and memory disposed in the body,
a wireless transceiver disposed in the body,
a global positioning system (GPS) decoder disposed in the body, and
a camera secured to the body,
wherein software code residing in the memory and executed by the processor enables the flying drone to follow a predetermined flight path and obtain images of a plurality of individual parking spaces in the parking facility and wirelessly relay the images of the plurality of individual parking spaces to the parking management computer system via the wireless transceiver.

2. The parking monitoring system of claim 1, further comprising a drone dock located at the parking facility and configured to interface with the fling drone.

3. The parking monitoring system of claim 1, wherein the images of the plurality of individual parking spaces are still images with encoded time stamps.

4. The parking monitoring system of claim 1, wherein the parking management computer system is configured to analyze the images of the plurality of individual parking spaces to determine an identification of each vehicle parked in the plurality of individual parking spaces.

5. The parking monitoring system of claim 1, wherein the software code residing in the memory and executed by the processor enables the flying drone to receive updated GPS coordinates from the parking management computer system and then utilize the updated GPS coordinates for a subsequent cycle of imaging of the plurality of individual parking spaces.

6. The parking monitoring system of claim 5, wherein the updated GPS coordinates correspond to vehicle location data obtained from a satellite image.

7. The parking monitoring system of claim 1, wherein the camera is mounted so that its elevation angle can be automatically adjusted.

8. The parking monitoring system of claim 1, wherein the flying drone comprises four electric fans to provide flight thrust to the flying drone.

9. The parking monitoring system of claim 1, wherein the flying drone further comprises an altitude sensor provided to the body.

10. The parking monitoring system of claim 1, wherein the software code residing in the memory and executed by the processor enables the flying drone to perform a cycle of imaging of the plurality of individual parking spaces with a pre-set periodic frequency.

11. The parking monitoring system of claim 1, wherein the parking facility is a parking ramp, a parking garage, an open parking lot, or a street segment.

12. A method of monitoring vehicles in a parking facility comprising a plurality of individual parking spaces, the method comprising:
a flying drone following a predetermined flight path and obtaining images of a plurality of individual parking spaces in the parking facility;
the flying drone wirelessly relaying the images of the plurality of individual parking spaces to a parking management computer system; and
the parking management computer system analyzing the images of the plurality of individual parking spaces to determine an identification for each vehicle parked in the parking facility.

13. The method of claim 12, further comprising sending GPS coordinates from the parking management computer system to the flying drone, wherein the GPS coordinates identify a plurality of locations for the flying drone to image.

14. The method of claim 12, further comprising sending at least one altitude value from the parking management computer system to the flying drone, wherein the at least one altitude value identifies an altitude for the flying drone to obtaining the images of a plurality of individual parking spaces in the parking facility.

15. The method of claim 12, further comprising receiving by the parking management computer system an image from a satellite orbiting Earth, and the parking management computer system determining automatically from the image from the satellite GPS coordinates for the flying drone to image in the parking facility corresponding to location of vehicles within the parking facility.

16. The method of claim 12, further comprising docking the flying drone upon completion of an imaging cycle.

17. The method of claim 12, wherein the step of the flying drone obtaining images of the plurality of individual parking spaces in the parking facility is performed at a pre-set periodic frequency.

18. The method of claim 12, further comprising performing by the parking management computing system a diagnostics routine on the flying drone.

19. The method of claim 12, further comprising the flying drone imaging a location where parking is prohibited.

20. The method of claim 12, further comprising the parking management computing system automatically generating a parking violation notice for a vehicle imaged by the flying drone that is determined by the parking management computing system to be in violation status.
